(19) United States
(12) Patent Application Publication
(10) Pub. No.: US 2015/0304602 A1
(43) Pub. Date: Oct. 22, 2015

(54) REDUCING DISK SPACE USAGE THROUGH LINKAGE OF A DIGITAL VIDEO RECORDER AND STREAMING MEDIA SOURCES

(71) Applicant: International Business Machines Corporation, Armonk, NY (US)

(72) Inventors: Lisa Seacat DeLuca, Baltimore, MD (US); Pamela A. Nesbitt, Raleigh, NC (US)

(73) Assignee: International Business Machines Corporation, Armonk, NY (US)

(21) Appl. No.: 14/258,163

(22) Filed: Apr. 22, 2014

(51) Int. Cl. H04N 5/85

(52) U.S. Cl. CPC H04N 5/85

(57) ABSTRACT

An approach for reducing disk space usage on a digital video recorder (DVR) is provided. The approach comprises determining whether a program in a recording queue of programs that are to be recorded by the digital video device is provided by a streaming media source. In response to determining that the program is provided by the streaming media source, the approach further comprises creating, on the digital video device, a placeholder for playing the program, wherein the placeholder links the program to the streaming media source.

### TECHNICAL FIELD OF THE INVENTION

The present invention relates generally to a device of digital video recording, and more particularly to reducing disk space usage on a digital video recorder.

### BACKGROUND

Nowadays, people are faced with a wide variety of programs, such as television episodes and movies, to be watched. Because of a wide array of venues for acquisition, storage, and viewing of these programs and because of people's desire to save everything for later viewing, there is a tendency for people to record the programs in duplication and then run out of local storage on recording devices such as digital video recorders (DVRs). A digital video recorder (DVR) is an electronic device or application software that records videos in a digital format to a disk drive or other storage devices. A user of a DVR or other video storage media will tend to save all the programs they like for future viewing; thus, they end up overfilling the DVR and leave insufficient space for other programs the user want to record. The user may not be aware that the valuable space used to store the programs on the DVR can be released to save something else.

### SUMMARY

In one aspect, a method for reducing disk space usage on a digital video recorder is provided. The method is complemented by a computer program residing in the digital video recorder. The method comprises determining whether a program in a recording queue of programs that are to be recorded by the digital video device is provided by a streaming media source. The method further comprises creating on the digital video device a placeholder for playing the program, in response to determining that the program is provided by the streaming media source, wherein the placeholder links the program to the streaming media source.

In another aspect, a computer program product for reducing disk space usage on a digital video recorder is provided. The computer program product comprises a computer readable storage medium, which has program code embodied therewith, in the digital video recorder. The program code is executable to determine whether a program in a recording queue of programs that are to be recorded by the digital video device is provided by a streaming media source. The program code is executable to create on the digital video device a placeholder for playing the program, in response to determining that the program is provided by the streaming media source, wherein the placeholder links the program to the streaming media source.

In yet another aspect, a computer system for reducing disk space usage on a digital video recorder is provided. The computer system in the digital video recorder comprises one or more processors, one or more computer-readable tangible storage devices, and program instructions stored on at least one of the one or more computer-readable tangible storage devices for execution by at least one of the one or more processors. The computer system comprises program instructions executable to determine whether a program in a recording queue of programs that are to be recorded by the digital video device is provided by a streaming media source. The computer system further comprises program instructions executable to create on the digital video device a placeholder for playing the program, in response to determining that the program is provided by the streaming media source, wherein the placeholder links the program to the streaming media source.

### BRIEF DESCRIPTION OF THE SEVERAL VIEWS OF THE DRAWINGS

FIG. 1 is a diagram illustrating data processing environment of a digital video recorder (DVR) and a plurality of streaming media sources, in accordance with one embodiment of the present invention.

FIG. 2 is a flowchart illustrating operating steps for reducing disk space usage on a digital video recorder (DVR), in accordance with one embodiment of the present invention.

FIG. 3 is a flowchart illustrating operating steps for erasing programs that have been recorded on a disk of a digital video recorder (DVR), in accordance with one embodiment of the present invention.

FIG. 4 is a diagram illustrating “Now Playing List” on a digital video recorder (DVR), in accordance with one embodiment of the present invention.

FIG. 5 is a diagram illustrating components of a computer system on a digital video recorder (DVR), in accordance with one embodiment of the present invention.

### DETAILED DESCRIPTION

An approach disclosed in embodiments of the present invention provides a linkage between a digital video recorder (DVR) queue and streaming media sources. For those programs which are available for instant viewing, the linkage yields the ability to prevent wasted storage space on the DVR.

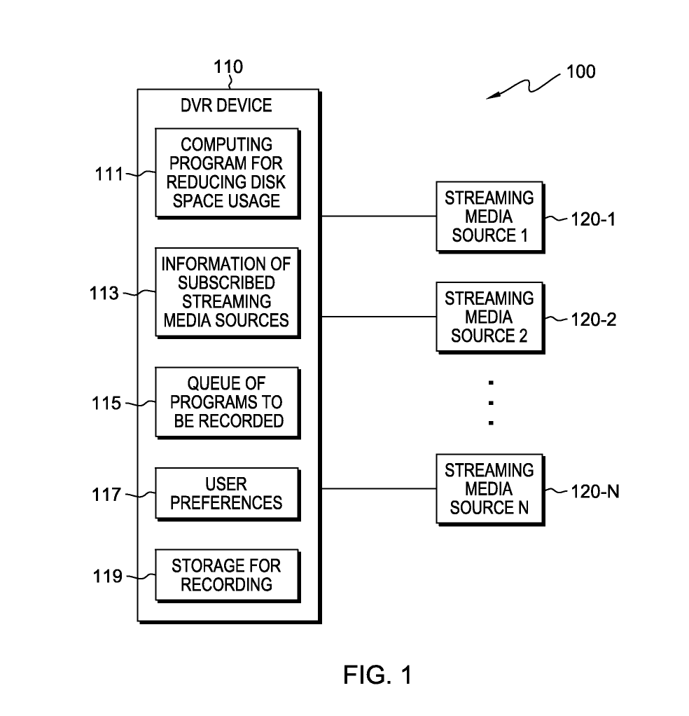

FIG. 1 is a diagram illustrating data processing environment 100 of DVR device 110 and a plurality of streaming media sources (streaming media sources 120-1 through 120-N), in accordance with one embodiment of the present invention. DVR device 110 comprises computer program 111 for reducing disk space usage. DVR device 110 is connected to streaming media sources 120-1 through 120-N. The connection between DVR device 110 and streaming media sources 120-1 through 120-N is through a network. Streaming media sources 120-1 through 120-N may be a provider of on-demand Internet streaming media available to viewers, such as Hulu, Netflix, and Amazon Prime. The network may be the Internet, which represents a worldwide collection of networks and gateways to support communications between devices connected to the Internet. The network may include, for example, wired, wireless, or fiber optic connections. In general, the network can be any combination of connections and protocols which support communications between DVR device 110 and streaming media sources 120-1 through 120-N.

To make a decision on reducing disk space usage, computer program 111 for reducing disk space usage retrieves information 113 of subscribed streaming media resources; the information is stored on DVR device 110. DVR device 110 also comprises storage 119 for recording; the storage is used to save programs (such as TV shows or movies provided by streaming media sources 120-1 through 120-N). DVR device 110 stores queue 115 of programs to be recorded on storage 119. When making a decision on whether a respective one of the programs in queue 115 is not recorded, computer program 111 also checks user preferences 117 which is set by a user of DVR device 110.

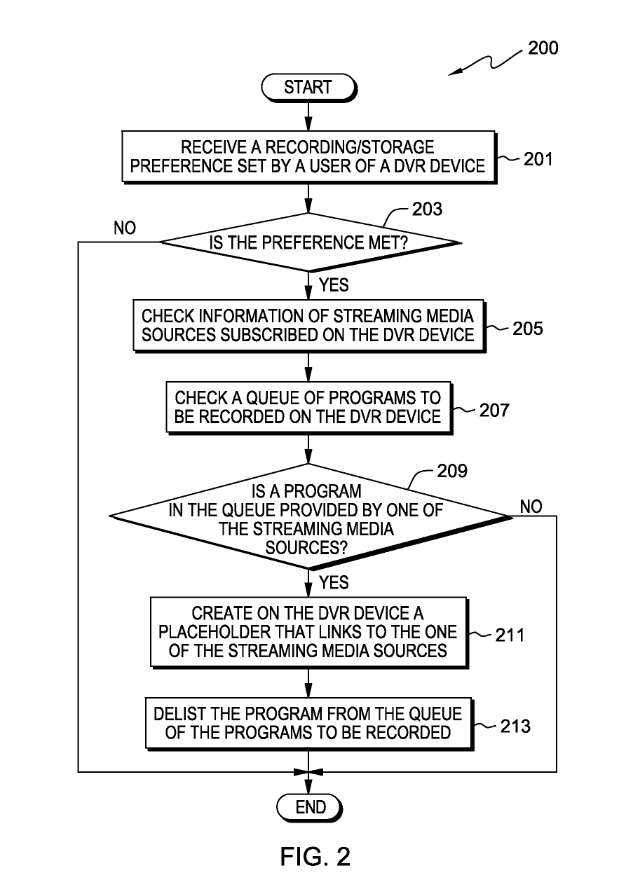

FIG. 2 is flowchart 200 illustrating operating steps for reducing disk space usage on DVR 110 (shown in FIG. 1), in accordance with one embodiment of the present invention. The operational steps are implemented by computer program 111 (shown in FIG. 1) for reducing disk space usage.

At step 201, computer program 111 receives a recording/storage preference set by a user of DVR 110. The recording/storage preference is one of user preferences 117 which are saved on DVR 110. The user preferences include a critical threshold of storage 119, an episode type, and episode priority. For example, the critical threshold of storage 119 is that the free storage space is below 1 gigabyte or the remaining storage capacity is below 10%. For example, the episode type includes programs from TV networks such as ABC, NBC, and FOX, or programs which have length of more than a certain hours. The recording/storage preference may be set as “always”, which indicates all programs will be considered.

At decision block 203, computer program 111 determines whether the recording/storage preference is met. In examples of the preferences mentioned in the last paragraph, the recording/storage preference is met if the free storage space is below 1 gigabyte, the remaining storage capacity is below 10%, programs are from TV networks such as ABC, NBC, and FOX, or programs have a length of more than a certain number of hours. In response to determining that the recording/storage preference is met (YES branch of decision block 203), computer program 111 at step 205 checks information of streaming media sources subscribed on DVR device 110. Computer program 111 processes step 205 and steps thereafter, when the recording/storage preference is met. In response to determining that the recording/storage preference is not met (NO branch of decision block 203), computer program 111 terminates; therefore, DVR device 110 will record programs in queue 115. If the user preference is set as “always”, computer program 111 processes step 205 and steps thereafter.

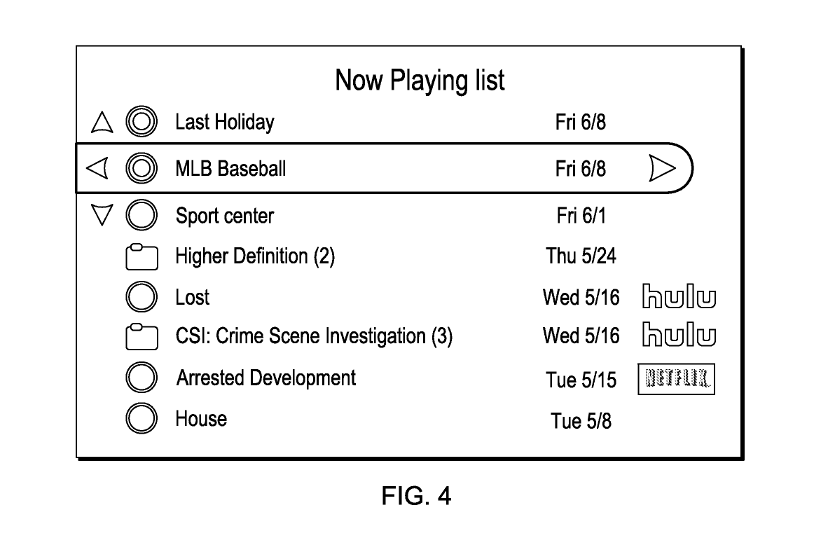

At step 207, computer program 111 checks a queue of programs to be recorded on DVR device 110. At decision block 209, computer program 111 determines whether a program in the queue is provided by one of streaming media sources 120-1 through 120-N. In response to determining that the program in the queue is not provided by the one of streaming media sources 120-1 through 120-N (NO branch of decision block 209), computer program 111 terminates; therefore, DVR device 110 will record the program. In response to determining that the program in the queue is provided by the one of streaming media sources 120-1 through 120-N (YES branch of decision block 209), at step 211, computer program 111 creates, on DVR device 110, a placeholder for the program. The placeholder links to the one of streaming media sources 120-1 through 120-N. The placeholder includes a visual indicator identifying the streaming media source. The placeholder enables the program to be seen on a playing list on DVR device 110. The user can see the program on the playing list on DVR device 110, such as the “Now Playing List” shown in FIG. 4. FIG. 4 is a diagram illustrating “Now Playing List” on DVR device 110, in accordance with one embodiment of the present invention. For example, the program “Lost” is on the “Now Playing List”; when the user clicks on “Lost” on the “Now Playing List”, DVR device 110 triggers the link to Hulu (a streaming media source) and plays “Lost”. In other embodiments, computer program 111 may alert the user of an option to watch the program from the one of streaming media sources 120-1 through 120-N.

At step 213, computer program 111 delists the program from the queue of the programs to be recorded. Therefore, DVR device 110 will not record the program thereon. Although the program is deleted from the queue of the programs to be recorded, the program can still been seen in a playing list on DVR device 110. For example, in FIG. 4 which illustrates “Now Playing List” on DVR device 110, in accordance with one embodiment of the present invention, the program “Lost” is deleted from the queue, but it is still on “Now Playing List” for the user to watch.

The program delisted from the queue of the programs to be recorded may become unavailable later; therefore, the program needs to be relisted in the queue of the programs to be recorded. In other embodiments, a computer program embodied on DVR device 110 determines whether the program is to be unavailable in the streaming media resource. The computer program relists the program in the recording queue, in response to determining that the program is to be unavailable in the streaming media resource.

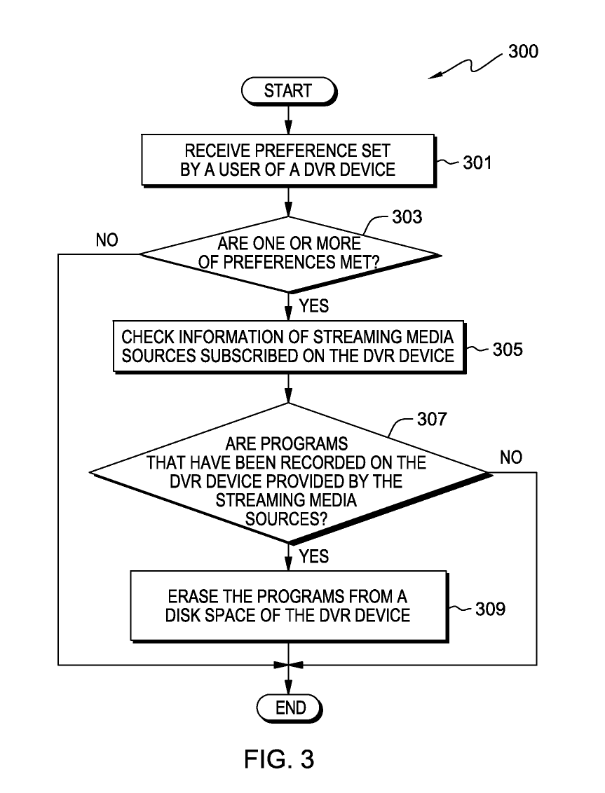

FIG. 3 is flowchart 300 illustrating operating steps for erasing programs that have been recorded on a disk of DVR device 110, in accordance with one embodiment of the present invention. The operational steps are implemented by computer program 111 (shown in FIG. 1) for reducing disk space usage.

At step 301, computer program 111 receives a recording/storage preference set by a user of DVR 110. The recording/storage preference is one of user preferences 117 which are saved on DVR 110. The user preferences have been discussed in a previous paragraph in reference to step 201 in FIG. 2.

At decision block 303, computer program 111 determines whether the recording/storage preference is met. How the recording/storage preference is met has been discussed in a previous paragraph in reference to step 203 in FIG. 2. In response to determining that the recording/storage preference is met (YES branch of decision block 303), computer program 111 at step 305 checks information of streaming media sources subscribed on DVR device 110. Computer program 111 processes step 305 and steps thereafter, when the recording/storage preference is met. If the user preference is set as “always”, computer program 111 processes step 305 and steps thereafter. In response to determining that the recording/storage preference is not met (NO branch of decision block 303), computer program 111 terminates; therefore, DVR device 110 will not erase any programs that have been recorded on storage 119 on DVR device 110.

At decision block 307, computer program 111 determines whether programs that have been recorded on DVR device 110 are provided by streaming media sources 120-1 through 120-N. In response to determining that the programs are provided by streaming media sources 120-1 through 120-N (YES branch of decision block 307), computer program 111 at step 309 erases the programs form storage 119 on DVR device 110. Although the programs are erased from storage 119 on DVR device 110, the program can still been seen in a playing list on DVR device 110. For example, in FIG. 4 which illustrates a “Now Playing List” on DVR device 110, in accordance with one embodiment of the present invention, “Arrested Development” is erased from storage 119 on DVR device 110, but it can still be seen on “Now Playing List”; when the user clicks “Arrested Development” on the list, DVR device 110 triggers the link to Netflix (a streaming media source) and plays “Arrested Development”. In response to determining that the programs are not provided by one of streaming media sources 120-1 through 120-N (NO branch of decision block 307), computer program 111 terminates; therefore, the programs will remain on storage 119 of DVR device 110.

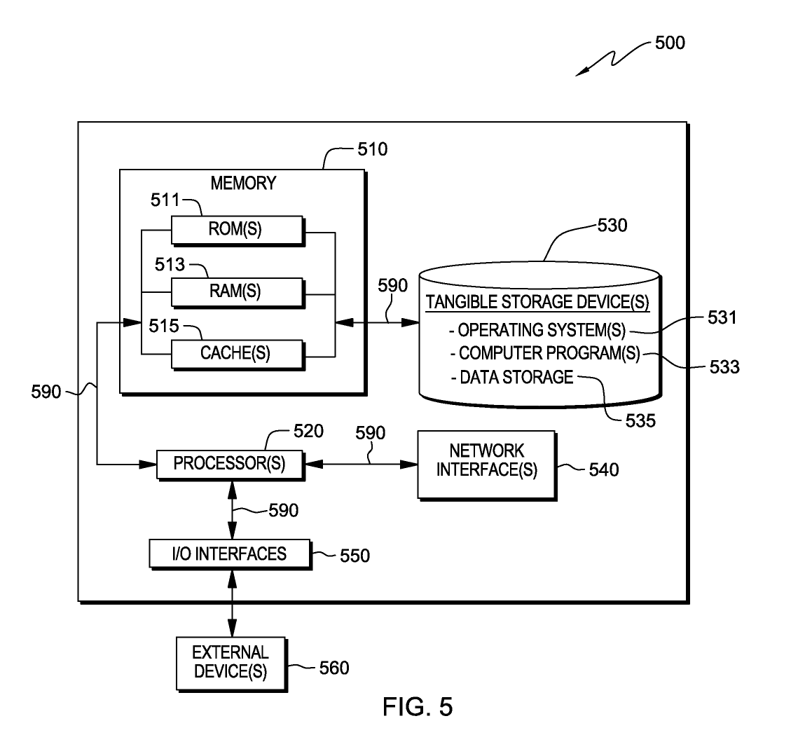

FIG. 5 is a diagram illustrating components of computer system 500 on DVR device 110 shown in FIG. 1, in accordance with one embodiment of the present invention. It should be appreciated that FIG. 5 provides only an illustration of one implementation and does not imply any limitations with regard to the environment in which different embodiments may be implemented.

Referring to FIG. 5, computer system 500 includes processor(s) 520, memory 510, tangible storage device(s) 530, network interface(s) 540, and I/O (input/output) interface(s) 550. In FIG. 5, communications among the above-mentioned components of computer system 500 are denoted by numeral 590. Memory 510 includes ROM(s) (Read Only Memory) 511, RAM(s) (Random Access Memory) 513, and cache(s) 515. One or more operating systems 531, one or more computer programs 533, and data storage 535 reside on one or more computer-readable tangible storage device(s) 530.

Computer system 500 further includes I/O interface(s) 550. I/O interface(s) 550 allow for input and output of data with external device(s) 560 that may be connected to computer system 500. Computer system 500 further includes network interface(s) 540 for communications between computer system 500 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for reducing disk space usage on a digital video recorder, the method implemented by a computer program embodied on a computer readable storage medium of the digital video recorder, the method comprising:
determining whether a program in a recording queue of programs that are to be recorded by the digital video device is provided by a streaming media source; and
creating on the digital video device a placeholder for playing the program, the placeholder linking the program to the streaming media source, in response to determining that the program is provided by the streaming media source.

2. The method of claim 1, further comprising:
delisting the program from the recording queue, in response to determining that the program is provided by the streaming media source.

3. The method of claim 1, further comprising:
determining whether a program that has been recorded on the digital video recorder is provided by one of streaming media sources; and
erasing from storage space on the digital video recorder the program that has been recorded on the digital video recorder, in response to determining that the program that has been recorded on the digital video recorder is provided by the one of the streaming media sources.

4. The method of claim 1, further comprising:
receiving a recording and storage preference set by a user of the digital video recorder; and
determining whether the preference is met.

5. The method of claim 1, wherein the placeholder includes a visual indicator identifying the streaming media source.

6. The method of claim 1, further comprising:
determining whether the program is to be unavailable in the streaming media resource; and
relisting the program in the recording queue, in response to determining that the program is to be unavailable in the streaming media resource.

7. A computer program product for reducing disk space usage on a digital video recorder, the computer program product comprising a computer readable storage medium in the digital video recorder, the computer readable storage medium having program code embodied therewith, the program code executable to:
determine whether a program in a recording queue of programs that are to be recorded by the digital video device is provided by a streaming media source; and
create on the digital video device a placeholder for playing the program, the placeholder linking the program to the streaming media source, in response to determining that the program is provided by the streaming media source.

8. The computer program product of claim 7, further comprising the program code executable to:
delist the program from the recording queue, in response to determining that the program is provided by the streaming media source.

9. The computer program product of claim 7, further comprising the program code executable to:
determine whether a program that has been recorded on the digital video recorder is provided by one of streaming media sources; and
erase from storage space on the digital video recorder the program that has been recorded on the digital video recorder, in response to determining that the program that has been recorded on the digital video recorder is provided by the one of the streaming media sources.

10. The computer program product of claim 7, further comprising the program code executable to:
receiving a recording and storage preference set by a user of the digital video recorder; and
determining whether the preference is met.

11. The computer program product of claim 7, wherein the placeholder includes a visual indicator identifying the streaming media source.

12. The computer program product of claim 7, further comprising the program code executable to:
determine whether the program is to be unavailable in the streaming media resource; and
relist the program in the recording queue, in response to determining that the program is to be unavailable in the streaming media resource.

13. A computer system for reducing disk space usage on a digital video recorder, the computer system in the digital video recorder comprising:
one or more processors, one or more computer-readable tangible storage devices, and program instructions stored on at least one of the one or more computer-readable tangible storage devices for execution by at least one of the one or more processors, the program instructions executable to:
determine whether a program in a recording queue of programs that are to be recorded by the digital video device is provided by a streaming media source; and
create on the digital video device a placeholder for playing the program, the placeholder linking the program to the streaming media source, in response to determining that the program is provided by the streaming media source.

14. The computer system of claim 13, further comprising the program instructions executable to:
delist the program from the recording queue, in response to determining that the program is provided by the streaming media source.

15. The computer system of claim 13, further comprising the program instructions executable to:
determine whether a program that has been recorded on the digital video recorder is provided by one of streaming media sources; and
erase from storage space on the digital video recorder the program that has been recorded on the digital video recorder, in response to determining that the program that has been recorded on the digital video recorder is provided by the one of the streaming media sources.

16. The computer system of claim 13, further comprising the program instructions executable to:
receiving a recording and storage preference set by a user of the digital video recorder; and
determining whether the preference is met.

17. The computer system of claim 13, wherein the placeholder includes a visual indicator identifying the streaming media source.

18. The computer system of claim 13, further comprising the program instructions executable to:
determine whether the program is to be unavailable in the streaming media resource; and
relist the program in the recording queue, in response to determining that the program is to be unavailable in the streaming media resource.
